(19) United States
(12) Patent Application Publication
(10) Pub. No.: US 2008/0288691 A1
(43) Pub. Date: Nov. 20, 2008

(54) METHOD AND APPARATUS OF LOCK TRANSACTIONS PROCESSING IN SINGLE OR MULTI-CORE PROCESSOR

(76) Inventors: Xiao Yuan Bie, Beijing (CN); Yi Ge, Beijing (CN); Zhiyong Liang, Beijing (CN); Peng Shao, Beijing (CN); Wen Bo Shen, Beijing (CN)

Correspondence Address: IBM CORPORATION, T.J. WATSON RESEARCH CENTER, P.O. BOX 218, YORKTOWN HEIGHTS, NY, 10598, US

(21) Appl. No.: 12/115,643

(22) Filed: May 6, 2008

(30) Foreign Application Priority Data
May 18, 2007 (CN) 200710105004.6

(51) Int. Cl. G06F 12/14

(52) U.S. Cl. 710/200

(57) ABSTRACT

The present invention relates to a method and apparatus of lock transactions processing in a single or multi-core processor. An embodiment of the present invention is a processor with one or more processing cores, an address arbitrator, where one or more processing cores are configured to submit a lock transaction request to the address arbitrator corresponding to a specific instruction in response to the execution of the specific instruction. The lock transaction request includes a lock variable address asserted on an address bus. The processor further includes a lock controller for performing lock transaction processing in response to the lock transaction request, and notifying processing result to the processing core from which the lock transaction request was sent. The processor further includes a switching device, coupled to the address arbitrator and the lock controller, for identifying the lock transaction request and notifying the lock transaction request to the lock controller.

### CROSS-REFERENCE TO RELATED APPLICATIONS

This application claims priority under 35 U.S.C. § 119 to Chinese Patent Application No. 200710105004.6 filed May 18, 2007, the entire contents of which is incorporated herein by reference.

### FIELD OF THE INVENTION

The present invention relates to a lock mechanism for shared memory in a multi-core processor. More specifically, the present invention relates to a lock mechanism based on address arbitrator for shared memory in a multi-core processor.

### BACKGROUND OF THE INVENTION

As the development of semiconductor technique, multi-core processors (for example, cell processors) are widely used. Multi-thread programs running on cores of a multi-core processor must control the concurrent access to the shared memory region. The common way of the control is to synchronize the threads by lock/semaphore. Therefore the efficiency of lock/semaphore implementations is a key factor for the performance of multi-thread platforms. The implementation of a lock will impact not only the overhead of synchronization operations, but also the block time of threads waiting for the release of the lock. This will be even critical to the success of current processors, which adopt multi-core multi-thread as an important technology to get full utilization of the die size.

Normally the lock/unlock operations have been implemented as a combination of hardware supported shared memory systems and atomic synchronization primitives, e.g. test-and-set (T&S), compare-and-swap (C&S), and load-linked/store-conditional (LL/SC). These hardware support shared memory systems provide a mechanism to block the global memory access/communications when an atomic primitive is ongoing, e.g., the bus lock in x86 processors. This works for the traditional shared memory multi-processor platforms, since the memory interface/bus is the only way for processors to carry out global communications. However, for current or future multi-core processors, this mechanism degrades the system performance in two aspects:

1. All the lock/unlock operations converge at the memory interface to resolve potential competitions. The off-chip memory interface was already the bottleneck of system, not only because of its bandwidth, but also the latency, which is about hundreds or thousands of times of the on-chip cache latency. Even if the access confliction can be resolved in shared on-chip L2/L3 cache, the overhead of operation is still one order of magnitude higher.

2. More and more network topologies are adopted as the global interconnection in multi-core chips, to support concurrent data transactions/communications. For example, there is a ring network in Cell processor.

FIG. 1 shows an example of such ring network in a cell processor. As shown in FIG. 1, PPE, SPE0-SPE7, MIC, IOIF1 and BIF/IOIF0 are processing cores in the cell processor. These processing cores access the ring network, as indicated by solid lines with arrows connected in series into rings shown in FIG. 1. The respective processing cores are connected with an address arbitrator (Data Arb) through bus interfaces as shown by narrow and long strips in FIG. 1. When a processing core is going to access the network to perform a data transaction, it firstly requests the address arbitrator to perform arbitration on address involved in its data transaction, and accesses the network to perform the data transaction under permission.

The network as shown in FIG. 1 can support up to 6 concurrent data transfer in a time. It can cause a worse performance downgrade if an atomic operation of a certain core has to block the global bus/network. Therefore, there is a need to provide a new lock mechanism for multi-core chips, for better lock performance.

### SUMMARY OF THE INVENTION

The illustrative embodiments of the present invention described herein provide a method, apparatus, and computer usable program product for detecting the order of wagons in a train. The embodiments described herein further provide if and how the order of wagons in a freight train is changed in a reliable manner.

An exemplary feature of an embodiment of the present invention is a processor consisting of one or more processing cores, an address arbitrator, where one or more processing cores are configured to submit to the address arbitrator a lock transaction request corresponding to a specific instruction in response to the execution of the specific instruction, and the lock transaction request includes a lock variable address asserted on an address bus. The processor further consists of a lock controller for performing lock transaction processing in response to the lock transaction request, and notifying a processing result to the processing core from which the lock transaction request was sent out. The processor further consists of a switching device, coupled to the address arbitrator and the lock controller, for identifying the lock transaction request and notifying the lock transaction request to the lock controller.

Another exemplary feature of an embodiment of the present invention is method for processing a lock transaction in a processor consisting of one or more processing cores, where one of the processing cores submits a lock transaction request corresponding to a specific instruction to a address arbitrator where the address arbitrator is to execute a specific instruction. The method further consists of the step of asserting a lock variable address on a address bus. The method further consists of the step of identifying the lock transaction request. The method further consists of the step of performing the lock transaction processing and notifying the processing result to one of the one or more processing cores.

Another exemplary feature of an embodiment of the present invention is a program storage device readable by a machine, tangibly embodying a program of instructions executable by the machine to perform method steps for method for processing a lock transaction in a processor with one or more processors. The method consists of one of the processing cores submits a lock transaction request corresponding to a specific instruction to a address arbitrator where the address arbitrator is to execute a specific instruction. The method further consists of the step of asserting a lock variable address on a address bus. The method further consists of the step of identifying the lock transaction request. The method further consists of the step of performing the lock transaction processing and notifying the processing result to one of the one or more processing cores.

Various other features, exemplary features, and attendant advantages of the present disclosure will become more fully appreciated as the same becomes better understood when considered in conjunction with the accompanying drawings, in which like reference characters designate the same or similar parts throughout the several views.

### BRIEF DESCRIPTION OF THE DRAWINGS

The figures form a part of the specification and are used to describe the embodiments of the invention and explain the principle of the invention together with the literal statement. The foregoing and other objects, aspects, and advantages will be better understood from the following non-limiting detailed description of preferred embodiments of the invention with reference to the drawings, wherein:

FIG. 1 shows an exemplary network topology in a cell processor according to an embodiment of the invention.

FIG. 2 shows an exemplary structure of a multi-core processor having fast lock mechanism, according to an embodiment of the invention.

FIG. 3 shows an exemplary signal connections between the processing unit and the address arbitrator and lock controller as shown in FIG. 2, according to an embodiment of the invention.

FIG. 4 shows an exemplary structure of the address arbitrator and lock controller as shown in FIG. 2, according to an embodiment of the invention.

FIG. 5 shows an exemplary structure of the lock lockup table in the address arbitrator and lock controller as shown in FIG. 2, according to an embodiment of the invention.

FIG. 6 is a flow chart for illustrating the operation procedure of test & set 0 (lock acquisition), according to an embodiment of the invention.

### DETAILED DESCRIPTION OF THE PREFERRED EMBODIMENTS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings.

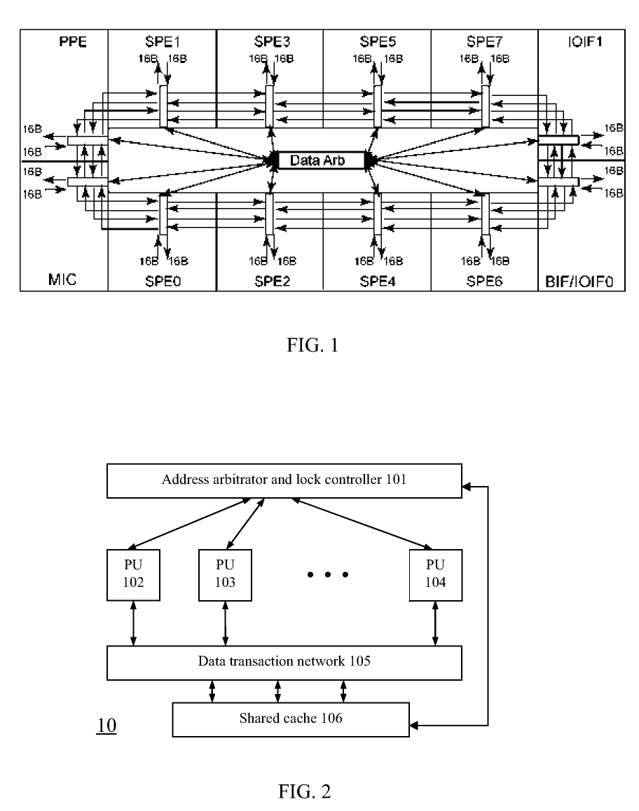

In the following description, an embodiment of the present invention will be described by referring to the structure of cell processor shown in FIG. 1. In addition, since the core mechanism of a semaphore is similar to that of a lock, only with certain difference in application aspects, if it is able to achieve the lock, it is certainly able to implement the semaphore, thus the invention is illustrated only by referring to the lock mechanism in the following.

FIG. 2 illustrates an exemplary structure of a multi-core processor 10 having a fast lock mechanism according to one embodiment of the present invention. As shown in FIG. 2, processor 10 comprises an address arbitrator and lock controller (AALC) 101, a plurality of processing units (PU) 102, 103, 104, data transaction network 105 and a shared cache 106. The topology of the data transaction network may be based on the ring network as shown in FIG. 1. For example, PUs 102, 103 and 104 may correspond to SPE in FIG. 1, and the address arbitrator and lock controller 101 may correspond to the address arbitrator Data Arb in FIG. 1.

PUs 102, 103 and 104 are processing cores running application threads. A single PU may run a single thread or run a plurality of threads at the same time. Like the ring network in FIG. 1, the data transaction network 105 is an interconnection network that connects the PUs and the shared cache, as well as delivers data transaction messages between the PUs and the cache. Like the address arbitrator Data Arb in FIG. 1, the address arbitrator and lock controller 101 receives data requests from PUs and arrange the schedule and routing of the transactions. As described below, the address arbitrator and lock controller 101 also obtains lock requests from PUs, checks/modifies the corresponding status of lock variables by which the status is maintained, and returns processing results of the lock requests to the requesting PUs. Preferably, the address arbitrator and lock controller 101 keeps only a portion of lock variables therein, while the entire lock variable set is mapped into the system memory. When required, the lock variables may be loaded into the address arbitrator and lock controller 101 through the on-chip cache 106. Thus, it is possible to flexibly accommodate the size of the lock variable set, i.e., increasing the scalability of the lock mechanism.

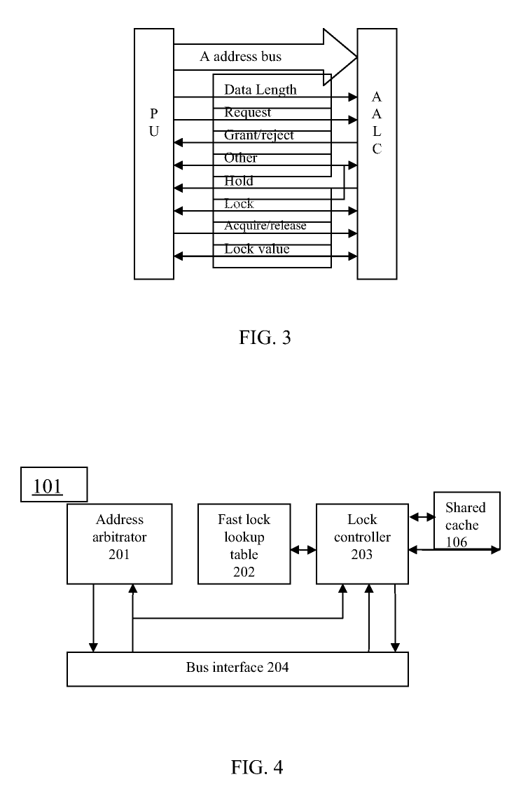

FIG. 3 illustrates an exemplary signal connection between the processing unit and the bus interface 204 of the address arbitrator and lock controller 101 as shown in FIG. 2. As shown in FIG. 3, signal lines “data length”, “request”, “grant/reject”, “other” and “hold” are signals for data transmission requests, which are similar to the bus interface as shown in FIG. 1, according to an embodiment of the present invention

FIG. 4 illustrates an exemplary structure of the address arbitrator and lock controller 101 as shown in FIG. 2, according to an embodiment of the present invention. As shown in FIG. 4, the address arbitrator and lock controller 101 comprises an address arbitrator 201, a fast lock lockup table 202, a lock controller 203 and a bus interface 204. The address arbitrator 201 is similar to the address arbitrator Data Arb as shown in FIG. 1. In the data transaction aspect, the bus interface 204 is similar to the bus interface in FIG. 1.

According to an embodiment of the present invention, the bus interface further comprises signal lines for lock operations, i.e., “lock” signal, “acquire/release” signal and “lock value”. A lock transaction is usually divided into three phases:

Request phase. When a PU requests for performing a lock transaction on a lock variable, the address of the lock variable is placed on the address bus to indicate the lock variable; the “lock” signal is asserted to notify the address arbitrator and lock controller 101 that the present request is directed to a lock transaction; and the type of requested lock transaction is asserted through the “acquire/release” signal, i.e., lock acquisition and lock releasing. In addition, information for identifying the thread issuing the request may be provided to the address arbitrator and lock controller 101 through, for example, “lock value” or an additional signal line.

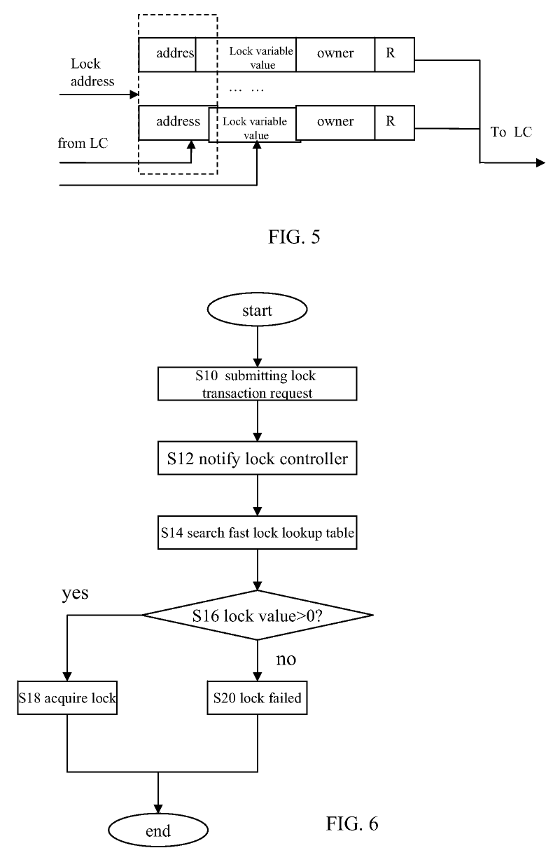

Processing phase. The address arbitrator and lock controller 101 performs corresponding processing (will be illustrated by referring to FIGS. 4 and 5 in the following) in response to the lock transaction request submitted by the PU on the bus interface 204.

Responding phase. In the lock transaction aspect, the “grant/reject” signal is used to indicate the type of result of the lock transaction request to the PU. For a lock transaction request from the PU, the address arbitrator and lock controller 101 may have 3 kinds of responses in the next cycle. The first is “grant” (indicated by the “grant/reject” signal), i.e., the lock transaction request is processed successfully. The second is “reject” (indicated by the “grant/reject” signal), i.e., the lock transaction request is failed. The third is “hold” (indicated by the “hold” signal), i.e., the lock transaction is paused because the lock variable involved with the lock transaction request is not in the address arbitrator and lock controller 101. For the third case, the address arbitrator and lock controller 101 further provides a lock ID to the PU through the “lock value” signal, to identify the paused lock transaction. When the requested lock variable is loaded into the address arbitrator and lock controller 101, the address arbitrator and lock controller 101 proceeds to process the lock transaction request and returns the final granting result (“grant/reject” signal) identified with the lock ID (“lock value” signal) to the requesting PU. For the third case, the correspondence between the requesting thread and the returned lock ID is maintained in the PU, in order to be able to find the relevant thread when receiving the final result.

An application can arbitrarily specify the memory location at an address as a lock variable because a specific lock variable is identified by the address on the address bus. Accordingly, the application is required to initialize a lock/semaphore before using the lock/semaphore, for example, writing an initial value or a magic number for lock transaction verification to the address. As stated above, a specific (lock/unlock) instruction is then used to perform atomic operation on the lock variable.

These lock signal operations by the PU on the bus interface 204 according to the specific instruction may be transparent for the program threads running on the PU. For example, for the multi-core processor (cell processor) shown in FIG. 1, the instruction set for its processing cores include instructions for lock operations, e.g., getlar, putllc, putlluc and putqlluc. When implementing the present invention, it is required to modify the instruction execution portion of the PU, so that when these instructions are encountered, corresponding lock transaction requests are issued through the bus interface 204 to execute corresponding lock transactions on the address arbitrator and lock controller 101. The lock transaction requests made by the PU depend on the semantic of the executed specific instructions.

The address arbitrator and lock controller 101 and the processing performed in response to the lock transaction requests will be described by referring to FIGS. 4 and 5, according to an embodiment of the present invention.

By referring again to FIG. 4, in the address arbitrator and lock controller 101, the data transaction portion of the bus interface 204 is identical to that of the bus interface as shown in FIG. 1, except for adding a switch logic (not shown) for determining whether a request submitted by the PU relates to a data transaction or a lock transaction according to the “lock” signal. If it is a data transaction, the address arbitrator 201 is enabled to process the transaction request; and if it is a lock transaction, the lock controller 203 is enabled to process the transaction request. The address arbitrator 201 is identical to the arbitrator as shown in FIG. 1.

The lock controller 203 is responsible for lockup table management, lock variable searching and updating, and lock transaction processing and so on. More specifically, when the lock controller 203 receives a lock transaction request from a PU through the bus interface 204, it obtains the address of a lock variable related to the lock request from the address bus, retrieves the lock variable corresponding to the address from the fast lock lockup table 202, performs corresponding modification to the retrieved lock variable according to the type of the lock transaction, and returns the result to the requesting PU. If there is no lock variable corresponding to the address found in the fast lock lockup table, the lock controller 203 loads the variable via the requesting PU or directly from the memory or shared cache. If required, it is possible to perform some format verification or conversion at the loading phase.

FIG. 5 shows an exemplary structure of the fast lock lockup table 202 in the address arbitrator and lock controller 101, according to an embodiment of the present invention. As shown in FIG. 5, the fast lock lockup table includes several entries, each entry corresponding to one lock variable and including: an address field for representing the memory address of the lock variable; a lock variable value field for recording the present value of the lock variable; an owner field for identifying the thread currently occupying the lock. Here, “fast” is relative, as long as it is able to comply with the searching performance requirement, and there is no absolute standard. The fast lock lockup table 202 may be a content addressable memory which compares the address provided by the lock controller 203 with the address item of all the entries. The lock variable value in the matched entry is returned to the lock controller 203 for further operations. If the lock controller 203 modifies the content of a selected entry in operation, the lock controller 203 returns the updated result to the lockup table. A R bit in the entry records variable access history which can be used to the entry replacement policy (e.g., least recently usage and so on) in the lock controller 203. Further, when a system process or application thread needs to reset a lock variable, it may repeatedly request to release the lock, until the lock controller 203 detects that the value of the lock variable is negative (assuming the initial value is 0). It should be noted that the present invention is not limited to the specific numerical values. The lock controller 203 may swap the reset lock variable out the lock lockup table.

An exemplary procedure of lock operation will be described by referring to FIG. 6, according to embodiment of the present invention. In an embodiment of the present invention, most of lock operations can be simplified as a transaction between the PU and the address arbitrator and lock controller 101.

FIG. 6 is a flow chart for illustrating the operation procedure of test & set 0 (lock acquisition), according to an embodiment of the present invention. As shown in FIG. 6, at step S10, the instruction execution portion of the PU identifies an instruction relating to lock operation, i.e., test & set 0 (lock acquisition) when executing a thread, and then submits a lock transaction request to the bus interface 204, including asserting an address of a related lock variable, asserting the “lock” signal and asserting the “acquire” signal. Then at step S12, the bus interface 204 identifies the lock transaction request according to the “lock” signal and notifies the lock controller 203. Then at step S14, the lock controller 203 obtains the address on the address bus from the bus interface 204 and searches a matched entry in the fast lock lockup table 202. Then at step S16, the fast lock lockup table 202 returns content of the matched entry to the lock controller 203. The lock controller 203 checks whether the lock variable value in the entry is larger than zero.

According to an embodiment of the present invention, if the lock variable value is larger than zero, then at step S18, the lock controller 203 asserts the “grant” signal through the bus interface 204 as a response to the requesting PU. Then the PU successfully acquires the lock. At the same time, the lock controller 203 decreases the value of the lock variable, and updates the lockup table entry with a new value and owner (PU). If the lock variable value is less than or equal to zero, then at step S20, the lock controller 203 asserts the “reject” signal through the bus interface 204 as a response to the requesting PU. The lock acquisition operation is failed or a zero is returned for the T & S instruction.

Although the instruction execution portion of the PU in the embodiment is required to identify the special instructions relating to lock operations, it is also possible to perform lock variable access by using a specially stated memory region or specific addresses of identifiable characteristics. In the latter case, if the instruction execution portion identifies that the address related to an instruction fall within the memory region or belongs to the specific addresses, it is treated as lock operation.

Although the embodiments of the present invention have been described by referring to a multi-core processor, a person skilled in the art knows that, because of the use of the lock ID and owner field, different threads in the same core are able to identify responses to their respective lock requests, and for the same lock variable, the lock controller is able to discriminate different thread in the same core. Therefore, the present invention is also applicable to a single core processor (a special example of the multi-core processor).

Although examples of specific signal lines have been provided to illustrate the interface between the PU and the address arbitrator and lock controller, one skilled in the art knows that, the present invention is not limited to these specific examples, but is able to be modified according to specific needs to perform processing relating to lock transactions.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

What is claimed is:

1. A processor, comprising:
one or more processing cores;
an address arbitrator, wherein said one or more processing cores are configured to submit to said address arbitrator a lock transaction request corresponding to a specific instruction in response to the execution of said specific instruction, said lock transaction request including a lock variable address asserted on an address bus;
a lock controller, for performing a lock transaction processing in response to said lock transaction request, and notifying a processing result to said processing core from which said lock transaction request was sent out.
a switching device, coupled to said address arbitrator and said lock controller, for identifying said lock transaction request and notifying said lock transaction request to said lock controller;

2. The processor of claim 1, wherein said address arbitrator further comprises a lock lockup table, for storing information relevant to a recently operated lock variables, wherein said lock transaction processing is performed based on said lock lockup table.

3. The processor of claim 2, wherein said lock lockup table further comprises a content addressable memory.

4. The processor according to claim 2, wherein said lock controller further comprises being further configured as, when the absence of said lock variable for said lock transaction request in said lock lockup table is detected, fetching said lock variable from an external storage location into said lock lockup table.

5. The processor according to claim 4, wherein said lock controller further comprises being further configured when the absence of said lock variable for said lock transaction request in said lock lockup table is detected, notifying a requesting processing unit that a present transaction is held.

6. A method for processing a lock transaction in a processor comprising one or more processing cores, comprising:
one of said one or more processing cores submitting a lock transaction request corresponding to a specific instruction to a address arbitrator when said address arbitrator is to execute a specific instruction;
asserting a lock variable address on a address bus;
identifying said lock transaction request; and
performing said lock transaction processing and notifying a processing result to one of said one or more processing cores.

7. The method according to claim 6, wherein said lock transaction processing being performed is based on a lock lockup table for storing information relevant to recently operated lock variables.

8. The method of claim 7, wherein said lock lockup table further comprises a content addressable memory.

9. The method according to claim 7, wherein said lock transaction processing further comprises fetching said lock variable from a external storage location into said lock lockup table when the absence of the lock variable for said lock transaction request in said lock lockup table is detected,

10. The method according to claim 9, wherein said lock transaction processing further comprises notifying a requesting processing unit that the present transaction is held when the absence of said lock variable for said lock transaction request in said lock lockup table is detected.

11. A computer program product comprising a computer useable medium including a computer readable program, wherein said computer readable program when executed on a computer causes the computer to perform the method steps for processing a lock transaction in a processor comprising one or more processing cores. The method comprising the steps of:
one of said one or more processing cores submitting a lock transaction request corresponding to a specific instruction to a address arbitrator when said address arbitrator is to execute a specific instruction;
asserting a lock variable address on a address bus;
identifying said lock transaction request; and
performing said lock transaction processing and notifying a processing result to one of said one or more processing cores.
